(19) United States
(12) Patent Application Publication
(10) Pub. No.: US 2005/0143119 A1
(43) Pub. Date: Jun. 30, 2005

(54) Method and apparatus for providing individual power control information in a wireless local area network/wireless wide area network (WLAN/WWAN)

(75) Inventors: Arty Chandra, Manhasset Hills, NY (US); Teresa Joanne Hunkeler, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/975,977

(22) Filed: Oct. 28, 2004

Related U.S. Application Data
(60) Provisional application No. 60/533,539, filed on Dec. 31, 2003.

(51) Int. Cl. H04B 7/00

(52) U.S. Cl. 455/522; 455/67.11; 455/343.5

(57) ABSTRACT

Method and apparatus employed by wireless network components such as access points (APs) for controlling transmitting power level of individual wireless transmitter/receiver units (WTRUs) by establishing a power transmit level based on prior transmit and receiving transmission and reception statistics such as signal to noise ratio (SNR), bit error rate (BER), frame error rate (FER) and/or the like. Power transmit level information is preferably communicated through any one of a clear to send (CTS), request to send (RTS), data and acknowledge (ACK) frame. Alternatively the power control information may be inserted into a beacon frame or an individual control frame specifically designated for power control. The WTRUs preferably have battery level sensors and adjust power control level responsive to a sensed battery level. Alternatively, the APs and WTRUs may reverse roles and the WTRUs may provide power transmit level information to an AP to facilitate transmissions by the AP.

### CROSS REFERENCE TO RELATED APPLICATION(S)

This application claims the benefit of U.S. provisional application No. 60/533,539, filed Dec. 31, 2003, which is incorporated by reference as if fully set forth.

### FIELD OF INVENTION

The present invention relates to wireless local area networks/wireless wide area networks (WLANs/WWANs) and more particularly to method and apparatus for use in WLANs/WWANs to provide individualized power information.

### BACKGROUND

Wireless communication systems are well known in the art. Generally, such systems comprise communication stations, which transmit and receive wireless communication signals between each other. Depending upon the type of system, communication stations typically are one of two types of wireless transmit/receive units (WTRUs): base stations or subscriber units, which include mobile units.

The term base station as used herein includes, but is not limited to, a base station, Node B, site controller, access point or other interfacing device in a wireless environment that provides WTRUs with wireless access to a network with which the base station is associated.

The term WTRU as used herein includes, but is not limited to, a user equipment, mobile station, fixed or mobile subscriber unit, pager, or any other type of device capable of operating in a wireless environment. WTRUs include personal communication devices, such as phones, video phones, and Internet ready phones that have network connections. In addition, WTRUs include portable personal computing devices, such as PDAs and notebook computers with wireless modems that have similar network capabilities. WTRUs that are portable or can otherwise change location are referred to as mobile units. Generically, base stations are also WTRUs.

Typically, a network of base stations is provided where each base station is capable of conducting concurrent wireless communications with appropriately configured WTRUs. Some WTRUs are configured to conduct wireless communications directly between each other, i.e., without being relayed through a network via a base station. This is commonly called peer-to-peer wireless communications. Where a WTRU is configured communicate with other WTRUs it may itself be configured as and function as a base station. WTRUs can be configured for use in multiple networks with both network and peer-to-peer communications capabilities.

One type of wireless system, called a wireless local area network (WLAN), can be configured to conduct wireless communications with WTRUs equipped with WLAN modems that are also able to conduct peer-to-peer communications with similarly equipped WTRUs. Currently, WLAN modems are being integrated into many traditional communicating and computing devices by manufacturers. For example, cellular phones, personal digital assistants, and laptop computers are being built with one or more WLAN modems.

Popular WLAN environments with one or more WLAN base stations, typically called access points (APs), are built according to the IEEE 802.11 standards. Access to these networks usually requires user authentication procedures. Protocols for such systems are presently being standardized in the WLAN technology area. One such framework of protocols is the IEEE 802 family of standards.

A basic service set (BSS) is the basic building block of an IEEE 802.11 WLAN and this consists of WTRUs also referred to as stations (STAs). Basically, the set of WTRUs which can talk to each other can form a BSS. Multiple BSSs are interconnected through an architectural component, called distribution system (DS), to form an extended service set (ESS). An access point (AP) is a WTRU that provides access to DS by providing DS services and generally allows concurrent access to DS by multiple WTRUs.

A network of WTRUs operating with peer to peer communications in an IEEE 802.11 environment, typically referred to as “ad hoc” mode, is called “independent BSS”. In an “independent BSS”, two or more WTRUs establish a communication among themselves without the need of a coordinating network element. There are no AP to network infrastructure required. However, an AP can be configured with the ad hoc protocols to act as the other WTRUs in peer to peer communications. In such case an AP may act as a bridge or router to another network or to the Internet.

The WTRU that starts an ad hoc network selects the ad hoc network's operating parameters, such as the service set identifier (SSID), channel and beacon timing, and the transmits this information in, for example, Beacon frames. As stations join the ad hoc network, they assimilate the operating parameters. Where network infrastructure is used and wireless communications are controlled through APs, parameters such as the SSID are normally specified by a network controller connected to APs which periodically broadcast a beacon frame to enable WTRUs to identify the AP and attempt to establish communications.

The SSID in a IEEE 802 based system can be a 32-character unique identifier attached to a header of packets sent over a WLAN. The SSID then acts as a password when a WTRU attempts to connect to a BSS or an independent BSS. The SSID differentiates one WLAN from another, so all base stations and all devices attempting to connect to a specific WLAN normally use the same SSID. A device will not normally be permitted to join a BSS unless it can provide the unique SSID.

On a broader scale a wireless wide area network (WWAN) can be provided to support communications between APs or other types of network base stations and user WTRUs. Cellular networks operating over great distances are one type of WWAN.

Typically, APs provided in WLANs/WWANs broadcast power constraint information which is utilized by all WTRUs communicating with an AP to reduce transmit power. The inventors have recognized that it would be desirable to provide for reducing/increasing transmit power of each WTRU and/or other connection or device, individually.

### SUMMARY

The present invention is characterized by comprising method and apparatus for use in wireless local area networks/wireless wide area networks (WLANs/WWANs) capable of providing transmit power information to individual wireless transmit/receive units (WTRUs).

A transmit power level is preferably established based on prior transmission and reception statistics such as signal to noise ration (SNR), bit error rate (BER), frame error rate (FER) and/or the like. The desired power transmit information is preferably communicated to a particular WTRU in a header of any one of a clear-to-send (CTS), request-to-send (RTS), data or acknowledge (ACK) frame that designated for that WTRU. The computation of the power level and transmission of power transmit information may be done at an AP for controlling the transmission power of a WTRU with which the AP is communicating or at a WTRU for controlling the transmission power of frames from an AP that are directed to the WTRU.

The individual transmit power information can optionally by conveyed by an AP through a beacon frame which is adapted to include both WTRU identities and power control data of the targeted WTRUs, preferably in addition to an initial power control setting for use by WTRUs when first initiating communications. Alternatively, a specifically designated for power control frame is provided in which the power control information is inserted. However, it is preferable to communicate the power control information in a frame that is also used for other purposes in order not to adversely effect network throughput.

In one aspect of the invention, a wireless transmit receive unit (WTRU) has a transmitter configured to broadcast general power constraint messages to other WTRUs and an associated processor. The processor is preferably configured to determine a desired power transmission level for a given WTRU and to insert data reflective of the desired power transmission level along with identity data of said given WTRU in a communication frame. The transmitter is preferably configured to transmit communication frames including desired power transmission level and identity data to enable said given WTRU to adjust transmission power of wireless signals directed to the WTRU irrespective of the general power constraint message. Preferably such a WTRU is configured as an access point (AP) of a wireless local area network (WLAN) having its transmitter configured to broadcast the general power constraint messages in beacon frames.

The processor of such an AP may be configured to insert data reflective of the desired power transmission level by inserting the desired power transmission level data into the beacon frames. Alternatively the processor can be configured to insert data reflective of the desired power transmission level by inserting the desired power transmission level data into standard clear-to-send (CTS), request-to-send (RTS), data or acknowledge (ACK) frames or into an individual control frame specifically designated for power control.

Additionally, the AP processor may be configured to insert data in given bits of a physical layer convergence procedure (PLCP) header to identify the desired power transmission level data that is being sent in the frame.

Other alternatives include, the AP processor being configured to insert data reflective of the desired power transmission level by inserting the desired power transmission level data in a given number of the initial bytes of a data part of the frame or by inserting the desired power transmission level data in a Medium Access Control (MAC) header. The AP processor may also be configured to insert data reflective of the AP transmission power level in the communication frame along with the desired power transmission level and identity data of said given WTRU.

Preferably, the AP processor is configured to determine the desired transmit power level by utilizing prior transmit and receive statistics by determining and storing data including at least one of signal to noise ratio (SNR), bit error rate (BER) and frame error rate (FER), transmit power of signals received from the given WTRU in addition to prior messages dealing with transmit and receive power levels.

In another aspect of the invention, a WTRU is configured for use in a wireless network with a receiver, a transmitter and an associated processor. The receiver is preferably configured to receive a broadcast of a general power constraint message from an access point (AP) of the wireless network. The receiver is preferably further configured to receive a communication frame from the AP having data reflective of a desired power transmission level along with identity data of the WTRU. The processor is preferably configured to adjust transmission power of wireless signals directed to the AP based on the received desired power transmission level data irrespective of the general power constraint message. The WTRU's receiver is preferably configured to receive the broadcast of general power constraint messages in beacon frames in a wireless local area network (WLAN).

The WTRU's transmitter can be configured to transmit a non-conforming adjustment message to the AP when the processor's adjustment of transmission power of wireless signals directed to the AP based on the received desired power transmission level data is effected by WTRU determined criteria. In such case, the WTRU's processor is preferably configured to adjust transmission power of wireless signals directed to the AP based on the received desired power transmission level data and based on at least one WTRU determined criteria from among remaining battery capacity, maximum power level, minimum power level and unsupported features.

Where the WTRU includes a battery to provide electric power, the processor can be configured to adjust transmission power of wireless signals directed to the AP by measuring remaining battery energy capacity and modifying transmission power based on the received desired power transmission level data and the measured remaining energy capacity. In such case, the processor is preferably configured to adjust transmission power of wireless signals directed to the AP by using the received desired power transmission level data as a basis for adjustment when the measured remaining energy capacity of the battery is above a given threshold and by using the received desired power transmission level data as a basis for adjustment and reducing the adjustment as a function of a difference of the measured remaining energy capacity and the given threshold when the measured remaining energy capacity of the battery is below the given threshold. The WTRU's transmitter can then be configured to transmit a low battery message to the AP when the power adjustment is reduced.

The WTRU's processor can also be configured to determine a desired AP power transmission level for AP transmissions to the WTRU and to insert data reflective of the desired AP power transmission level along with identity data of the WTRU in a communication frame. In such case, the transmitter is configured to transmit the communication frame whereby the AP is enabled to adjust transmission power of wireless signals directed to the WTRU. Preferably, the WTRU's processor is configured to insert data reflective of the desired AP power transmission level by inserting the desired AP power transmission level data into a clear-to-send (CTS), request-to-send (RTS), data or acknowledge (ACK) frame or an individual control frame specifically designated for power control. Similarly, such a WTRU's processor can be configured to insert data as discussed above for the example of an AP's processor.

Although the features and elements of the present invention are described in the preferred embodiments in particular combinations, each feature or element can be used alone (without the other features and elements of the preferred embodiments) or in various combinations with or without other features and elements of the present invention.

### BRIEF DESCRIPTION OF THE DRAWING(S)

The present invention will be understood from consideration of the drawings in which like elements are designated by like numerals and, wherein:

FIG. 1 is a simplified block diagram of a WLAN network.

FIG. 2 is a schematic diagram showing an example of the manner in which an AP generates and sends power transmit information.

FIG. 3 is a schematic diagram showing the manner in which a WTRU adjusts its power transmit output responsive to power transmit information from an AP and the battery consumption of the WTRU.

FIG. 4 is a schematic diagram showing an example of the manner in which a WTRU generates and sends power transmit information.

### DETAILED DESCRIPTION OF THE PREFERRED EMBODIMENT(S)

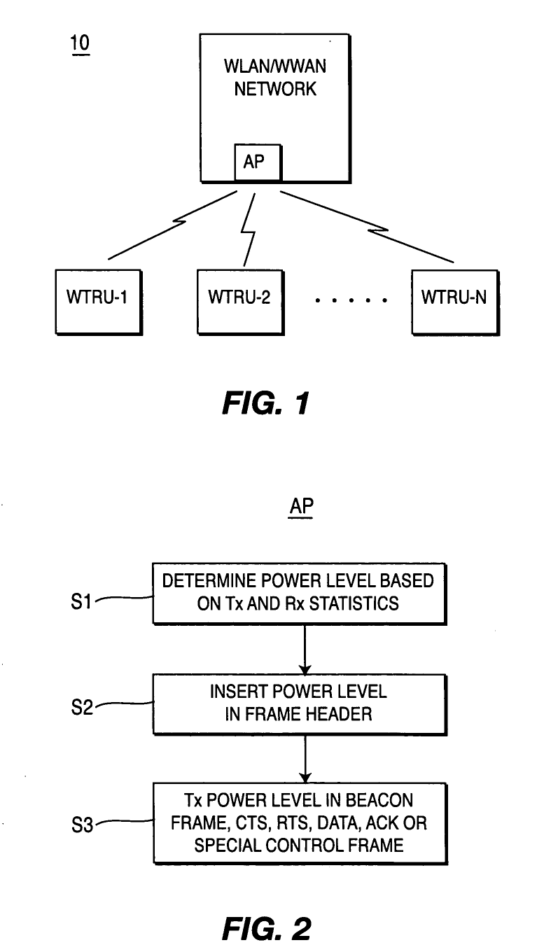

FIG. 1 shows a wireless local area network/wireless wide area network (WLAN/WWAN) 10 comprised of at least one AP and a plurality of wireless transmit/receive units (WTRUs), WTRU-1 through WTRU-N, communicating therewith. Each AP is capable of transmitting power information to WTRUs within its communication range and each WTRU is likewise capable of transmitting power information to APs within its communication range.

In existing standards, such as the IEEE 802.11h standard (Section 7.3.2.1.3), a local power constraint element is sent in a beacon frame by all APs. This local power constraint presently in use sets the transmit power of all WTRUs to the same value. The present invention distinguishes therefrom and is unique in providing individual transmit power value to each WTRU particularly in the context of WLANs/WWANs configured to operate in compliance with the IEEE 802.11 standards.

FIG. 2 illustrates a method and apparatus of the present invention employed by an access point (AP) of one of a WLAN or WWAN. At step S1, the AP determines a power level for a given remote WTRU, the power level being based on prior transmission and reception statistics utilizing information such as signal to noise ration (SNR), bit error rate (BER), frame error rate (FER) and/or the like. At step S2, the AP preferably inserts power level data power constraint message for the given WTRU in a frame header of a frame such as a clear-to send (CTS), request-to send (RTS), data or acknowledgment (ACK) frame that is directed to the specific WTRU. The AP, at step S3, transmits the frame that includes the power level data. The transmit power level data may take the form of a power constraint message and/or may be actual transmit power, a transmit power amount lower than a maximum power or higher than a minimum power or an increase/decrease from the last transmitted transmit power.

As one example, in a physical layer convergence procedure (PLCP) header, eight (8) bits are reserved for service. These bits are employed to indicate that power control information is sent in the frame. A first few bytes of the data part of the frame are employed to send the power control information. The AP is preferably configured to transmit such frames with power control information, and the WTRUs are preferably configured to receive such frames and detect the power control information in such a frame.

Preferably, the AP is configured to compute a transmit power level of an individual WTRU during single or multiple frame exchange. Also, the AP is preferably configured to communicate the data representing the computed power transmit level directly to the individual WTRU, apart from any generally transmitted beacon frame.

The individual transmit power data can optionally be inserted by an AP into a beacon frame which is adapted to include both WTRU identities and power control data of targeted WTRUs with which the AP is communicating. Irrespective of whether this option is used, the AP is preferably configured to broadcast beacon frames that include an initial power control setting for use by WTRUs when first initiating communications. Correspondingly, the WTRUs are preferably configured to only use the initial power control setting of received beacon frames, if the WTRU has not received individual transmit power data from the AP.

Alternatively, a specifically designated for power control frame is provided in which the power control information is inserted. However, it is preferable to communicate the power control information in a frame that is also used for other purposes in order not to adversely effect network throughput.

APs having a smart or adaptable antenna capability can use the present invention to great advantage which enables use of lower power control information due to the enhanced ability of the AP antenna, which capability, when present, factors into the transmission (TX) characteristics.

In addition WTRUs are provided with a power control algorithm to adjust power level taking into account battery consumption as well as the power control information from the AP.

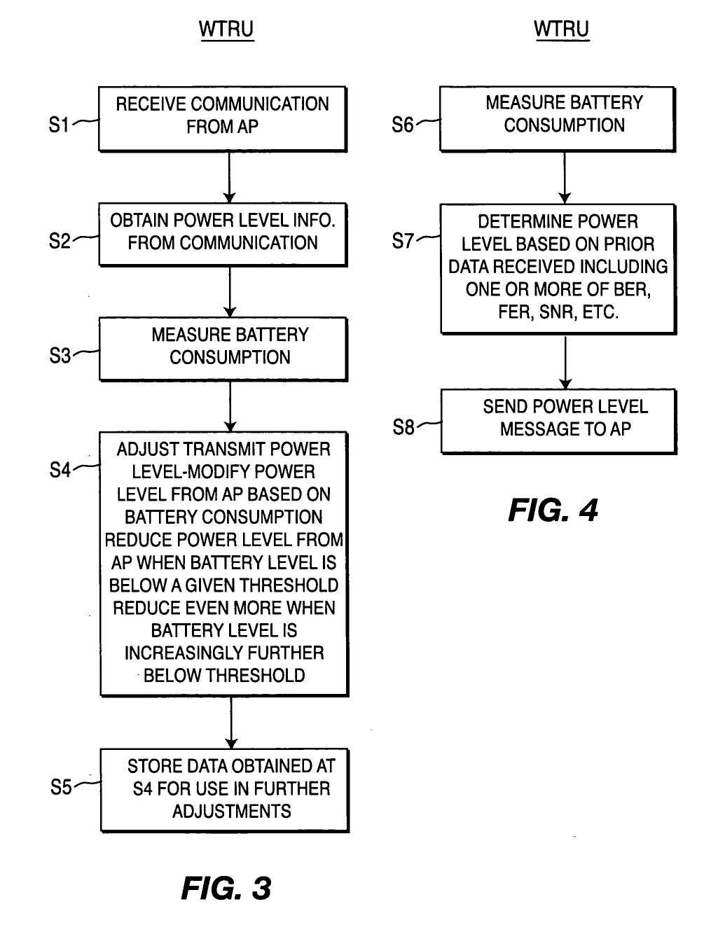

A preferred operational configuration for a WTRU employing the teachings of the invention is illustrated in FIG. 3. The WTRU, after receiving a designated frame that includes the power transmit information, at step S1, extracts the power level message, at S2, and, at step S3, measures battery consumption. The WTRU, at step S4, is preferably configured to adjusts its transmitting power level taking into account both the received power transmit information and battery related data which it measures. Prefeably, the WTRU, at step S4, uses the transmit power level derived from the AP, but reduces that power level when the measured battery level is below a given threshold. The amount of reduction of the transmit power level is preferably calculated as a function of increasingly lower battery level below the threshold. The results of the adjustments made, at step S4, are stored, at step S5, for use in future power level adjustments.

A noted above, a WTRU may provide a power level data to an AP to control the power of the transmissions of the AP directed to that WTRU. A preferred operational configuration for such a WTRU is illustrated in FIG. 4. The WTRU, at step S6, measures battery consumption. At step S7 the WTRU determines a power level based on prior reception data including one or more of BER, FER, SNR, etc, but modifies this information to increase the determined power level when the measured battery level is below a given threshold. Corresponding power level data is then sent to the AP, at step S8. The AP uses this information in determining power level for communications with the WTRU. The AP can also use this information in determining its transmission power for communications with other WTRUs and/or in computing power level data to be sent to WTRUs to control their repective transmission powers.

In order to perform the functions described above, the WTRU is configured with apparatus incorporating a receiver having an antenna configured to receive the defined frames transmitted by the AP. Where modulated signals are transmitted, the receiver is preferably configured with a demodulator to reduce the received signals to baseband. The WTRU is further preferably configured with apparatus to extract the targeted power constraint signal. For battery operated WTRUs, a sensor is preferably provided that is configured to measure energy capacity of the WTRU battery source.

The WTRU also preferably includes a transmitter having an adjustable transmission power level and a controller configured to set the power transmission level based upon either a received power constraint message taken alone, or a power constraint message modified according to energy capacity of a portable power source when such infomation is available. The controller may further be configured to modify the power level adjustment to one of a plurality of levels based upon the magnitude of the difference between maximum energy capacity remaining in a battery source and measured energy capacity or the difference between a preset threshold and measured energy capacity.

The WTRU controller is preferably configured to store measured energy capacity reading and generate a power level message which is forwarded to an AP as part of an RTS or ACK frame. The WTRU receiver may further be configured to measure power level of a beacon frame, which reading is then stored. The WTRU controller is then preferably configured to provide the transmitter with the measured power level as part of or in addition to the power level in WTRU identification message transmitted to the AP.

The AP is preferably configured with a receiver for receiving the WTRU message and converting the message to baseband. An AP controller is preferably configured to generate a power level constraint message based upon information in messages received from a WTRU and previously stored source data and provide power level data in the form of a power constraint message to an AP transmitter.

The AP is further preferably configured to insert the power constraint message into one of a CTS, RTS, ACK, or data frame and to insert data into a PLCP header to identify the power constraint message that is being sent in the frame along with an identity code to identify the WTRU intended to receive the frame and associated power constraint message.

The WTRUs and APs may reverse roles and the WTRUs may utilize the techniques set forth above to provide information equivalent to a power constraint message to aid the AP in its transmissions.

Although the features and elements of the present invention are described in the preferred embodiments in particular combinations, each feature or element can be used alone (without the other features and elements of the preferred embodiments) or in various combinations with or without other features and elements of the present invention.

1. A method employed by an access point (AP) of a wireless network to control transmit power of a targeted wireless transmit receive units (WTRUs), said method comprising:
determining a desired power transmission level for a given WTRU;
inserting data reflective of the determined desired power transmission level along with identity data of said given WTRU in a communication frame; and
transmitting said communication frame whereby said given WTRU is enabled to adjust transmission power of wireless signals directed to the AP.

2. The method of claim 1 wherein the determining of the desired transmit power level includes utilizing prior transmit and receive statistics by determining and storing data including at least one of signal to noise ratio (SNR), bit error rate (BER), frame error rate (FER), transmit power of signals received from the given WTRU in addition to prior messages dealing with transmit and receive power levels.

3. The method of claim 2 wherein the AP has an adjustable antenna and the determining of the desired transmit power level includes modifying the desired transmit power level responsive to an adjustment of said adjustable antenna.

4. The method of claim 1 further comprising:
inserting data in given bits of a physical layer convergence procedure (PLCP) header to identify the power control information that is being sent in the frame.

5. The method of claim 1 wherein the inserting data reflective of the determined desired power transmission level includes inserting desired power transmission level data in a given number of initial bytes of a data part of the frame.

6. A method employed by a wireless transmit receive unit (WTRU) in a wireless network comprising:
broadcasting a general power constraint message to other WTRUs;
determining a desired power transmission level for a given WTRU;
inserting data reflective of the desired power transmission level along with identity data of said given WTRU in a communication frame; and
transmitting said communication frame whereby said given WTRU is enabled to adjust transmission power of wireless signals directed to the WTRU irrespective of the general power constraint message.

7. The method of claim 6 wherein the WTRU is an access point (AP) of a wireless local area network (WLAN) and broadcasting a general power constraint message is performed by the AP in beacon frames.

8. The method of claim 7 wherein the inserting data reflective of the desired power transmission level includes inserting the desired power transmission level data into the beacon frames.

9. The method of claim 7 wherein the inserting data reflective of the desired power transmission level includes inserting the desired power transmission level data into a clear-to-send (CTS), request-to-send (RTS), data or acknowledge (ACK) frame.

10. The method of claim 9 further comprising inserting data in given bits of a physical layer convergence procedure (PLCP) header to identify the desired power transmission level data that is being sent in the frame.

11. The method of claim 9 wherein the inserting data reflective of the desired power transmission level includes inserting the desired power transmission level data in a given number of the initial bytes of a data part of the frame.

12. The method of claim 9 wherein the inserting data reflective of the desired power transmission level includes inserting the desired power transmission level data in a Medium Access Control (MAC) header.

13. The method of claim 9 further comprising inserting data reflective of the AP transmission power level in the communication frame along with the desired power transmission level and identity data of said given WTRU.

14. The method of claim 7 wherein determining the desired transmit power level includes utilizing prior transmit and receive statistics by determining and storing data including at least one of signal to noise ratio (SNR), bit error rate (BER) and frame error rate (FER), transmit power of signals received from the given WTRU in addition to prior messages dealing with transmit and receive power levels.

15. The method of claim 7 wherein the inserting data reflective of the desired power transmission level includes inserting the desired power transmission level data into an individual control frame specifically designated for power control.

16. A wireless communication method for a wireless transmit receive unit (WTRU) in a wireless network comprising:
receiving a broadcast of a general power constraint message from an access point (AP) of the wireless network;
establishing a wireless communication association with the AP;
receiving a communication frame from the AP having data reflective of a desired power transmission level along with identity data of the WTRU; and
adjusting transmission power of wireless signals directed to the AP based on the received desired power transmission level data irrespective of the general power constraint message.

17. The method of claim 16 wherein the broadcast of a general power constraint message is received in beacon frames in a wireless local area network (WLAN).

18. The method of claim 16 wherein the WTRU is powered by a battery and the adjusting transmission power of wireless signals directed to the AP further includes:
measuring remaining battery energy capacity; and
modifying transmission power based on the received desired power transmission level data and the measured remaining energy capacity.

19. The method of claim 18 wherein the adjusting transmission power of wireless signals directed to the AP includes using the received desired power transmission level data as a basis for adjustment when the measured remaining energy capacity of the battery is above a given threshold.

20. The method of claim 19 wherein the adjusting transmission power of wireless signals directed to the AP includes using the received desired power transmission level data as a basis for adjustment and reducing the adjustment as a function of a difference of the measured remaining energy capacity and the given threshold when the measured remaining energy capacity of the battery is below the given threshold.

21. The method of claim 20 further comprising transmitting a low battery message to the AP when the power adjustment is reduced.

22. The method of claim 16 further comprising transmitting a non-conforming adjustment message to the AP when the adjusting transmission power of wireless signals directed to the AP based on the received desired power transmission level data is effected by WTRU determined criteria.

23. The method of claim 22 wherein the adjusting transmission power of wireless signals directed to the AP based on the received desired power transmission level data is also based on at least one WTRU determined criteria from among remaining battery capacity, maximum power level, minimum power level and unsupported features.

24. The method of claim 16 further comprising:
determining a desired AP power transmission level for AP transmissions to the WTRU;
inserting data reflective of the desired AP power transmission level along with identity data of the WTRU in a communication frame; and
transmitting said communication frame whereby the AP is enabled to adjust transmission power of wireless signals directed to the WTRU.

25. The method of claim 24 wherein the inserting data reflective of the desired AP power transmission level includes inserting the desired AP power transmission level data into a clear-to-send (CTS), request-to-send (RTS), data or acknowledge (ACK) frame.

26. The method of claim 25 further comprising inserting data in given bits of a physical layer convergence procedure (PLCP) header to identify the desired AP power transmission level data that is being sent in the frame.

27. The method of claim 25 wherein the inserting data reflective of the desired AP power transmission level includes inserting the desired power transmission level data in a given number of the initial bytes of a data part of the frame.

28. The method of claim 25 wherein the inserting data reflective of the desired AP power transmission level includes inserting the desired AP power transmission level data in a Medium Access Control (MAC) header.

29. The method of claim 24 wherein determining the desired AP transmit power level includes utilizing prior transmit and receive statistics by determining and storing data including at least one of signal to noise ratio (SNR), bit error rate (BER) and frame error rate (FER), transmit power of signals received from the AP in addition to prior messages dealing with transmit and receive power levels.

30. The method of claim 24 wherein the inserting data reflective of the desired AP power transmission level includes inserting the desired power transmission level data into an individual control frame specifically designated for power control.

31. A wireless communication method for a wireless transmit receive unit (WTRU) in a wireless network comprising:
receiving a broadcast of a general power constraint message from an access point (AP) of a wireless local area network (WLAN);
establishing a wireless communication association with the AP;
determining a desired AP power transmission level for AP transmissions to the WTRU;
inserting data reflective of the desired AP power transmission level along with identity data of the WTRU in a communication frame; and
transmitting said communication frame whereby the AP is enabled to adjust transmission power of wireless signals directed to the WTRU.

32. The method of claim 31 wherein the inserting data reflective of the desired AP power transmission level includes inserting the desired AP power transmission level data into a clear-to-send (CTS), request-to-send (RTS), data or acknowledge (ACK) frame.

33. The method of claim 32 further comprising inserting data in given bits of a physical layer convergence procedure (PLCP) header to identify the desired AP power transmission level data that is being sent in the frame.

34. The method of claim 32 wherein the inserting data reflective of the desired AP power transmission level includes inserting the desired power transmission level data in a given number of the initial bytes of a data part of the frame.

35. The method of claim 32 wherein the inserting data reflective of the desired AP power transmission level includes inserting the desired AP power transmission level data in a Medium Access Control (MAC) header.

36. The method of claim 31 wherein determining the desired AP transmit power level includes utilizing prior transmit and receive statistics by determining and storing data including at least one of signal to noise ratio (SNR), bit error rate (BER) and frame error rate (FER), transmit power of signals received from the AP in addition to prior messages dealing with transmit and receive power levels.

37. The method of claim 31 wherein the inserting data reflective of the desired AP power transmission level includes inserting the desired power transmission level data into an individual control frame specifically designated for power control.

38. A wireless transmit receive unit (WTRU) configured for use in a wireless network comprising:
a transmitter configured to broadcast general power constraint messages to other WTRUs;
a processor configured to determine a desired power transmission level for a given WTRU and to insert data reflective of the desired power transmission level along with identity data of said given WTRU in a communication frame; and
said transmitter configured to transmit communication frames including desired power transmission level and identity data to enable said given WTRU to adjust transmission power of wireless signals directed to the WTRU irrespective of the general power constraint message.

39. The WTRU according to claim 38 configured as an access point (AP) of a wireless local area network (WLAN) wherein said transmitter is configured to broadcast the general power constraint messages in beacon frames.

40. The AP of claim 39 wherein said processor is configured to insert data reflective of the desired power transmission level by inserting the desired power transmission level data into the beacon frames.

41. The AP of claim 39 wherein said processor is configured to insert data reflective of the desired power transmission level by inserting the desired power transmission level data into a clear-to-send (CTS), request-to-send (RTS), data or acknowledge (ACK) frame.

42. The AP of claim 41 wherein said processor is configured to insert data in given bits of a physical layer convergence procedure (PLCP) header to identify the desired power transmission level data that is being sent in the frame.

43. The AP of claim 41 wherein said processor is configured to insert data reflective of the desired power transmission level by inserting the desired power transmission level data in a given number of the initial bytes of a data part of the frame.

44. The AP of claim 41 wherein said processor is configured to insert data reflective of the desired power transmission level by inserting the desired power transmission level data in a Medium Access Control (MAC) header.

45. The AP of claim 41 wherein said processor is configured to insert data reflective of the AP transmission power level in the communication frame along with the desired power transmission level and identity data of said given WTRU.

46. The AP of claim 39 wherein said processor is configured to determine the desired transmit power level by utilizing prior transmit and receive statistics by determining and storing data including at least one of signal to noise ratio (SNR), bit error rate (BER) and frame error rate (FER), transmit power of signals received from the given WTRU in addition to prior messages dealing with transmit and receive power levels.

47. The AP of claim 39 wherein said processor is configured to insert data reflective of the desired power transmission level by inserting the desired power transmission level data into an individual control frame specifically designated for power control.

48. A wireless transmit receive unit (WTRU) for use in a wireless network comprising:
a receiver configured to receive a broadcast of a general power constraint message from an access point (AP) of the wireless network;
said receiver further configured to receive a communication frame from the AP having data reflective of a desired power transmission level along with identity data of the WTRU; and
a transmitter having an associated processor configured to adjust transmission power of wireless signals directed to the AP based on the received desired power transmission level data irrespective of the general power constraint message.

49. The WTRU of claim 48 wherein receiver is configured to receive the broadcast of general power constraint messages in beacon frames in a wireless local area network (WLAN).

50. The WTRU of claim 49 further comprising a battery to provide electric power and wherein said processor is configured to adjust transmission power of wireless signals directed to the AP by measuring remaining battery energy capacity and modifying transmission power based on the received desired power transmission level data and the measured remaining energy capacity.

51. The WTRU of claim 50 wherein said processor is configured to adjust transmission power of wireless signals directed to the AP by using the received desired power transmission level data as a basis for adjustment when the measured remaining energy capacity of the battery is above a given threshold.

52. The WTRU of claim 51 wherein said processor is configured to adjust transmission power of wireless signals directed to the AP by using the received desired power transmission level data as a basis for adjustment and reducing the adjustment as a function of a difference of the measured remaining energy capacity and the given threshold when the measured remaining energy capacity of the battery is below the given threshold.

53. The WTRU of claim 52 wherein said transmitter is configured to transmit a low battery message to the AP when the power adjustment is reduced.

54. The WTRU of claim 48 wherein said transmitter is configured to transmit a non-conforming adjustment message to the AP when said processor's adjustment of transmission power of wireless signals directed to the AP based on the received desired power transmission level data is effected by WTRU determined criteria.

55. The WTRU of claim 54 wherein said processor is configured to adjust transmission power of wireless signals directed to the AP based on the received desired power transmission level data and based on at least one WTRU determined criteria from among remaining battery capacity, maximum power level, minimum power level and unsupported features.

56. The WTRU of claim 48 wherein said processor is configured to determine a desired AP power transmission level for AP transmissions to the WTRU and to insert data reflective of the desired AP power transmission level along with identity data of the WTRU in a communication frame and wherein said transmitter is configured to transmit said communication frame whereby the AP is enabled to adjust transmission power of wireless signals directed to the WTRU.

57. The WTRU of claim 56 wherein said processor is configured to insert data reflective of the desired AP power transmission level by inserting the desired AP power transmission level data into a clear-to-send (CTS), request-to-send (RTS), data or acknowledge (ACK) frame.

58. The WTRU of claim 57 wherein said processor is configured to insert data in given bits of a physical layer convergence procedure (PLCP) header to identify the desired AP power transmission level data that is being sent in the frame.

59. The WTRU of claim 57 wherein said processor is configured to insert data reflective of the desired AP power transmission level by inserting the desired power transmission level data in a given number of the initial bytes of a data part of the frame.

60. The WTRU of claim 57 wherein said processor is configured to insert data reflective of the desired AP power transmission level by inserting the desired AP power transmission level data in a Medium Access Control (MAC) header.

61. The WTRU of claim 56 wherein said processor is configured to determine the desired AP transmit power level by utilizing prior transmit and receive statistics by determining and storing data including at least one of signal to noise ratio (SNR), bit error rate (BER) and frame error rate (FER), transmit power of signals received from the AP in addition to prior messages dealing with transmit and receive power levels.

62. The WTRU of claim 56 wherein said processor is configured to insert data reflective of the desired AP power transmission level by inserting the desired power transmission level data into an individual control frame specifically designated for power control.

63. A wireless transmit receive unit (WTRU) for use in a wireless network comprising:
a receiver configured to receive a broadcast of a general power constraint message from an access point (AP) of the wireless network;
a processor configured to determine a desired AP power transmission level for AP transmissions to the WTRU and to insert data reflective of the desired AP power transmission level along with identity data of the WTRU in a communication frame; and
a transmitter configured to transmit said communication frame whereby the AP is enabled to adjust transmission power of wireless signals directed to the WTRU.

64. The WTRU of claim 63 wherein said processor is configured to insert data reflective of the desired AP power transmission level by inserting the desired AP power transmission level data into a clear-to-send (CTS), request-to-send (RTS), data or acknowledge (ACK) frame.

65. The WTRU of claim 64 wherein said processor is configured to insert data in given bits of a physical layer convergence procedure (PLCP) header to identify the desired AP power transmission level data that is being sent in the frame.

66. The WTRU of claim 64 wherein said processor is configured to insert data reflective of the desired AP power transmission level by inserting the desired power transmission level data in a given number of the initial bytes of a data part of the frame.

67. The WTRU of claim 64 wherein said processor is configured to insert data reflective of the desired AP power transmission level by inserting the desired AP power transmission level data in a Medium Access Control (MAC) header.

68. The WTRU of claim 63 wherein said processor is configured to determine the desired AP transmit power level by utilizing prior transmit and receive statistics by determining and storing data including at least one of signal to noise ratio (SNR), bit error rate (BER) and frame error rate (FER), transmit power of signals received from the AP in addition to prior messages dealing with transmit and receive power levels.

69. The WTRU of claim 63 wherein said processor is configured to insert data reflective of the desired AP power transmission level by inserting the desired power transmission level data into an individual control frame specifically designated for power control.
